(19) United States
(12) Patent Application Publication
(10) Pub. No.: US 2010/0213735 A1
(43) Pub. Date: Aug. 26, 2010

(54) Windshield-screen

(76) Inventor: Fu-Hsing Felix Lee, Dallas, TX (US)

Correspondence Address: Fu-Hsing Felix Lee, 6231 Cupertino Trail, Dallas, TX, 75252, US

(21) Appl. No.: 12/392,993

(22) Filed: Feb. 25, 2009

(51) Int. Cl. B60J 3/00

(52) U.S. Cl. 296/97.7

(57) ABSTRACT

The invention device consisting of one of the following lightweight and one or double-sided water proof coated materials (of either fabric, plastic or composite board), all of which are to be lightweight and one or double-sided water proof, will cover the exterior face of a parked auto vehicle's windshield, which said device's ends are to be attached to the vehicle's side mirrors with sturdy elastic-like or rope-like materials. The said device will prevent ice or snow from accumulating on the windshield and will prevent the excessive heat buildup within the vehicle via blocking the sun's rays.

### BACKGROUND OF THE INVENTION

I have lived in the apartment complex without covered parking several times in the past. In the cold winter day morning very often I needed to scratch the ice or snow from windshield before I could drive car to work. This is not the pleasant morning to start with. In the hot summer days, the temperature inside the car is more than 100 degree F. Due to the weather condition the windshield would cost more for maintenance when the parked vehicle without covered parking and the poor would suffer the most.

### BRIEF SUMMARY OF THE INVENTION

The invention device for a parked auto vehicle consists of a double or one-sided waterproof coated sheet material. The size and shape of the device is about the outline of a vehicle windshield.

The device has two rope-like or elastic-like materials located at the device's peripheral edges will be attached or tied to the parked vehicle's side mirrors.

The rope-like or elastic-like materials used to attach or tie the device to the parked auto vehicle's side mirrors aim to securely fasten the device to the auto vehicle.

During colder weather, ice and snow may directly accumulate on top of the windshield of an auto vehicle in uncovered parking areas. A user of the device will not need to scrape off the ice or snow that has accumulated on the windshield, possibly scratching the windshield and incurring contact-relate damages. The invention device will slow down the windshield material's fatigue that is caused by weather stresses, such as ice or heat.

### BRIEF DESCRIPTION OF THE SEVERAL VIEWS OF THE DRAWING

The views of the drawing of the invention device

FIG. 1 Shows the rectangle shape of the device which is about the outline of a vehicle windshield.

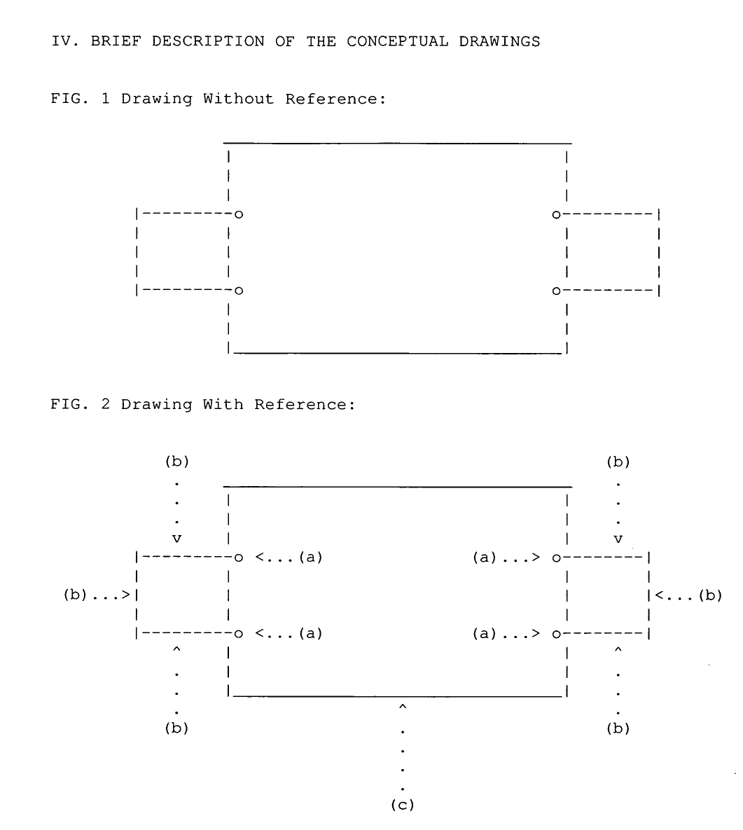

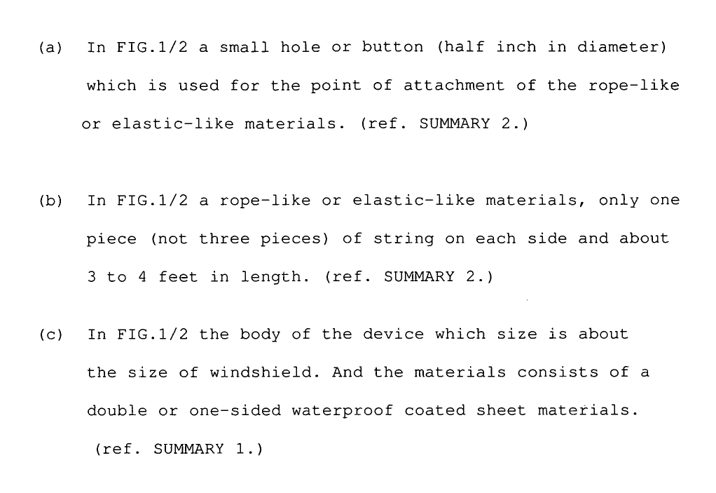

The FIG. 2 drawing shows the major components of the device such as rope-like materials on both sides of the panel and the holes to hold ropes.

### DETAILED DESCRIPTION OF THE INVENTION

1. The invention device for a parked auto vehicle consists of a double or one-sided waterproof coated sheet material. The device will be shaped and sized according to the outline of a auto vehicle windshield, and in addition, will be attached or tied to the parked vehicle's side mirrors via two rope-like or elastic-like materials located at the device's peripheral edges. The edges may be made sturdier with additional re-enforcement materials.

2. The rope-like or elastic-like materials used to attach or tie the device to the parked auto vehicle's side mirrors aim to securely fasten the device to the auto vehicle, thus preventing wind or other nature-like casualties that may cause detachment to the said device.

3. During colder weather, ice and snow may directly accumulate on top of the windshield of an auto vehicle in uncovered parking areas. A user of the said device will not need to scrape off the ice or snow that has accumulated on the windshield, possibly scratching the windshield and incurring contact-related damages. During hot days, the device, which lays directly on the windshield's exterior face, also serves to block the sun's rays, thus preventing the accumulation of heat within the auto vehicle.

4. The invention device is distinguished from other sun-ray blockers which blockers that are placed within the vehicle. In these cases, heat has already built up inside the vehicle between the blocker and windshield.

5. The invention device will slow down the windshield material's fatigue that is caused by weather stresses, such as ice or heat.

6. The invention device's windshield protective trait can benefit vehicle owners who do not have access to covered parking.

1. The invention device, consisting of one of the following lightweight and one or double-sided waterproof coated materials (either fabric, plastic, or composite board) will outline the exterior windshield face. The afore mentioned materials will be attached and tied securely to the auto vehicle's side mirrors with sturdy rope-like or elastic-like materials.

2. The invention device will prevent both the accumulation of ice and snow on the windshield in colder weather and the excessive heat buildup within the auto vehicle via blocking the sun's rays on hot days.
